(19) United States
(12) Patent Application Publication
(10) Pub. No.: US 2025/0022102 A1
(43) Pub. Date: Jan. 16, 2025

(54) DATA PROCESSING DEVICE AND METHOD FOR CORRECTING IMAGE SHADING

(71) Applicant: Leica Microsystems CMS GmbH, Wetzlar (DE)

(72) Inventors: Oliver SCHLICKER, Wetzlar (DE); Markus SCHECHTER, Wetzlar (DE); Kai WALTER, Wetzlar (DE)

(21) Appl. No.: 18/768,102

(22) Filed: Jul. 10, 2024

(30) Foreign Application Priority Data
Jul. 10, 2023 (DE) 102023118112.2

(51) Int. Cl. G06T 5/50; G06T 5/60; G06T 7/00

(52) U.S. Cl. CPC G06T 5/50; G06T 5/60; G06T 7/0002; G06T 2207/10056; G06T 2207/10064; G06T 2207/20081; G06T 2207/20084; G06T 2207/20224; G06T 2207/30168

(57) ABSTRACT

The invention relates to a data processing device for an imaging apparatus, the device being configured to obtain a length threshold value, to access input image data representing at least one digital input image, wherein the input image data comprise a shading signal representing a brightness decrease towards the edges of the at least one digital input image, and a content signal representing image features of the at least one digital input image, the image features having a length that is smaller than the length threshold value, to compute a baseline image based on the input image data and the length threshold value, wherein the baseline image is representative of an estimate of the shading signal, to generate at least one digital output image representative of an estimate of the content signal by at least one of a) subtracting the baseline image from the input image data and b) dividing the input image data by the baseline image. Advantageously, the data processing device allows a shading correction without the need for obtaining any separate background image or reducing the image size. The invention also relates to a computer-implemented method and a method for operating such an imaging apparatus. Further, the invention relates to a computer program and a computer-readable medium. Lastly, the invention relates to a neural network device trained by means of the data processing device or the computer-implemented method.

### CROSS-REFERENCE TO RELATED APPLICATION

This application claims priority to German Application 102023118112.2, which was filed on Jul. 10, 2023. The content of this earlier filed application is incorporated by reference herein in its entirety.

### TECHNICAL FIELD

The invention relates to a data processing device for an imaging apparatus such as a microscope, endoscope, scanner, camera, photon counter or any other type of scientific and medical observation device. The invention also relates to a computer-implemented method and a method for operating such an imaging apparatus. Further, the invention relates to a computer program and a computer-readable medium. Lastly, the invention relates to a neural network device trained by means of the data processing device or the computer-implemented method.

### BACKGROUND

When images of objects, such as samples are taken in the field of medicine and other scientific disciplines, lens vignetting as well as inhomogeneous illumination often cause a so-called shading effect that deteriorates image quality.

A known approach to overcome the shading effect is to acquire a background image with an empty sample holder. The background image can then be used to correct the actual image of the sample. This type of shading correction is tedious because the user must repeat it for every optical objective and contrasting method. Moreover, if illumination changes even slightly, the whole procedure has to be done all over again.

An alternative is the reduction of the image size in order to acquire only the well-illuminated center area of the field of view. With smaller image size, however, more images need to be taken to cover the same region of interest, which is time consuming. In addition, continuously illuminating the sample more than necessary can cause bleaching or even harm living samples.

Consequently, there is a need for conveniently applying a shading correction to images in the field of medicine and other scientific disciplines.

### SUMMARY

Thus, an object of the present invention is to provide means, which only require low effort and time for improving image quality, in general, and overcoming the shading effect, in particular.

This object is achieved by a data processing device for an imaging apparatus, the device being configured to obtain a length threshold value, to access input image data representing at least one digital input image, wherein the input image data comprise a shading signal representing a brightness decrease towards the edges of the at least one digital input image, and a content signal representing image features of the at least one digital input image, the image features having a length that is smaller than the length threshold value, to compute a baseline image based on the input image data and the length threshold value, wherein the baseline image is representative of an estimate of the shading signal, to generate at least one digital output image representative of an estimate of the content signal by at least one of a) subtracting the baseline image from the input image data and b) dividing the input image data by the baseline image.

Herein, the length of the individual image features is a length larger than zero in the input image domain, e.g. given as a number of length units or as a number of pixels in one direction along which the corresponding image feature extends. The length threshold value can be obtained as direct user input or calculatively as will be described below in further detail.

The data processing device according to the present invention is advantageous and achieves the above object for the following reasons:

The shading effect caused by lens vignetting and illumination inhomogeneity results in an inhomogeneous distribution of brightness in the image, brightness being the relative image intensity. The inhomogeneous brightness distribution tends to follow a certain pattern i.e., having a brighter center and darker edges. Said pattern usually spreads over a larger distance than the lengths of the image features. Further, said pattern is reflected in the above-mentioned shading signal.

As will be described below in further detail, the baseline image computed from the input image data and the length threshold value can be considered as primarily representing an approximation of the shading signal that does not include the content signal. This is because said baseline image is computed based on the length threshold value, which is larger than the lengths of the image features contained in the content signal. Thus, by computing the baseline image based on the length threshold value, it is possible to manipulate the baseline image into only representing a pattern of certain changes in image brightness of the at least one digital input image, these changes occurring gradually over a distance larger than the length threshold value.

In other words, the baseline image can be considered as a rough “brightness map”. Said “brightness map” can be used for identifying which part of the at least one input image is unduly dark as a result of the shading effect.

The estimated pattern contained in the baseline image can thus be used for shading correction in a subtractive or divisive manner in order to make dark regions of the at least one digital input image brighter in the at least one digital output image and/or bright regions of the at least one digital input image darker in the at least one digital output image. Consequently, in the at least one digital output image, the image brightness is effectively homogenized and the shading effect is minimized or at least mitigated.

Advantageously, the data processing device works without the need for obtaining any separate background image or reducing the image size.

The initial object is also achieved by a computer-implemented method for processing input image data of an imaging apparatus, the method comprising the steps of obtaining a length threshold value, accessing input image data representing at least one digital input image, wherein the input image data comprise a shading signal representing a brightness decrease towards the edges of the at least one digital input image, and a content signal representing image features of the at least one digital input image, the image features having a length that is smaller than the length threshold value, computing a baseline image based on the input image data and the length threshold value, wherein the baseline image is representative of an estimate of the shading signal, generating at least one digital output image representative of an estimate of the content signal by at least one of a) subtracting the baseline image from the input image data and b) dividing the input image data by the baseline image.

In other words, the method may comprise the steps of retrieving at least one digital input image containing image features, each image feature being characterized in its size by a length; obtaining a length threshold value representing a threshold value that is larger than all lengths of the image features; estimating a baseline image based on the at least one input image and the length threshold value, the baseline image representing a pattern of changes in image brightness, wherein the changes take place over a distance larger than the length threshold value; computing at least one digital output image by at least one of a) subtracting the baseline image from the input image data and b) dividing the input image data by the baseline image.

This method benefits from the same advantages as those explained for the inventive data processing device. In particular, it can be carried out along with or subsequently to the imaging process.

The at least one digital input image may be for example a one-dimensional, two-dimensional or three-dimensional image or an image of higher dimensionality. In particular, the digital input image may derive from a line scan camera, an area scan camera, a range camera, a stereo camera, a microscope camera, an endoscope camera or the like. The digital input image may be represented by the input image data at a number of input image locations, such as pixels or voxels. The input image data may be discrete intensity data and/or discrete color data for example.

In turn, the input image data are preferably represented by an n-dimensional array I(Xᵢ), where N is an integer equal to or larger than 1. I(Xᵢ) can be any value or combination of values at the location Xᵢ, such as a value representing an intensity of a color or “channel” in a color space, e.g. the intensity of the color R in RGB space, or a combined intensity of more than one color, e.g.

$$\frac{R + G + B}{3}$$

in RGB color space.

As will be described in further detail below, the baseline image can be computed using a fit to the input image data. Computationally, the result of this fit, i.e. the baseline image, is represented by discrete baseline image data at a number of baseline image locations, such as pixels or voxels. The baseline image data may be an n-dimensional array F_{b}(Xᵢ) having the same dimensionality as the input image data. Thus, for one-dimensional input image data, the baseline image may be presented as a discrete curve graph, while for a two-dimensional input image data, the baseline image may be presented as a discrete graph of a curved surface.

The at least one digital output image may comprise output image data represented by an n-dimensional array O(Xᵢ) at a number of output image locations, such as pixels or voxels.

The term Xᵢ is a shortcut notation for a tuple {X₁; . . . ; Xₘ} containing m location values and representing a discrete location Xᵢ—or the position vector to that location—in the array representing the input image data. The location Xᵢ may be represented by a pixel or a preferably coherent set of pixels in the input image data. The discrete location Xᵢ denotes e.g. a single location variable {X₁} in the case of one-dimensional input image data, a pair of discrete location variables {X₁; X₂} in the case of two-dimensional input image data and a triplet of discrete location variables {X₁; X₂; X₃} in the case of three-dimensional input image data. In the i-th dimension, the array may contain Mᵢ locations, i.e. Xᵢ={X_{i,1}, . . . , X_{i,m}_{ᵢ}}. In total, I(Xᵢ) may contain (m₁× . . . ×mₙ) elements. In the following, no reference will be made to a concrete location or a concrete dimension, rather the location in the digital input image, the digital output image or the baseline image is indicated simply by Xᵢ.

As described above, the input image data may be composed of the shading signal and the content signal, wherein the baseline image mainly represents the shading signal. That is, the above data processing device functions particularly well for applications where the content signal can be assumed to have a high spatial frequency e.g., being responsible for intensity and/or color changes that take place over a short distance in the digital input image, while the shading signal is assumed to have a low spatial frequency, i.e. leading to predominantly gradual intensity and/or color changes that extend over comparatively large regions of the digital input image.

Due to its low spatial frequency, the shading signal can be considered as following a more or less smooth baseline. The baseline image is an estimate of said baseline in the intensity data and/or color data. Therefore, the baseline image represents an approximation of the shading signal.

Under this assumption, the length threshold value may be expressed as a cutoff frequency ω_{cutoff}, wherein structures represented in the input image data having a spatial frequency higher than the cutoff frequency ω_{cutoff} are considered to constitute the content signal, whereas structures represented in the input image data with a spatial frequency lower than the cutoff frequency ω_{cutoff} are considered to belong to the shading signal. In other words, the length threshold value can be used to differentiate, whether a structure is to be considered as belonging to the content signal or the shading signal.

Alternatively, the length threshold value may be given as a predetermined threshold length λ, which denotes the spatial extent of the biggest or average image feature of interest along a single dimension. All structures that are smaller than the length threshold value are considered to constitute the content signal, while structures larger than the length threshold value are considered to be part of the shading signal.

Furthermore, alternatively, the length threshold value may also be expressed as the square root of the preferably square number of pixels, which the biggest or average image feature of interest takes up in the at least one digital input image. For example, if the biggest or average image feature of interest takes up 100 pixels, the length threshold value may be 10.

The data processing device and method may be improved further by adding one or more of the features described in the following. Each of these features may be added to the method and/or the data processing device independently of the other features. In particular, a person skilled in the art—with knowledge of the inventive data processing device—is capable of configuring the inventive method such that the inventive method is capable of operating the inventive data processing device. Moreover, each feature has its own advantageous technical effect, as explained hereinafter.

The accessed input image data can be recorded by the imaging apparatus in real-time. Alternatively, the accessed input image data can be retrieved, received or read out from a storage medium. This allows carrying out the shading correction during the imaging process as well as afterwards.

The at least one digital input image may be a transmitted-light microscopy image. In transmitted-light microscopy images, lens vignetting can cause the shading effect to create brightness decrease towards the edges and corners. In this type of application, the data processing device and method allow to mitigate effectively the shading effect.

Alternatively or additionally, the at least one digital input image may be a fluorescence image. In particular, the at least one digital input image may be a photon count image. Such a photon count image is representative of photon count values obtained from a photon detector. In the input image data, these photon count values are allocated at the corresponding image locations, e.g. pixels. As the image intensity and illumination for photon count images stand in a multiplicative relationship, it is preferred to generate the at least one digital output image by dividing the input image data by the baseline image in the course of the shading correction.

Dividing the input image data by the baseline image may be carried out as a multiplication of the input image data with the inverse of the baseline image F_{b}⁻¹(Xᵢ), the inverse of the baseline image being for example an invert color image of the baseline image:

$$O ( {X}_{i} ) = I ( {X}_{i} ) \cdot {F}_{b}^{- 1} ( {X}_{i} )$$

Alternatively, a pixel-wise division may be employed for all pixels:

$${O}_{{x}_{i}} = {I}_{{x}_{i}} \dot{{-}_{\cdot }} {F}_{b , {x}_{i}}$$

Optionally, the baseline image may be normalized to 1 before the pixel-wise division. That is, the brightest pixel of the baseline image may be given the value 1 in the normalized baseline image. All values of the remaining pixels in the normalized baseline image may be obtained from a linear interpolation, a bilinear interpolation, a nearest-neighbor interpolation, a Lanczos interpolation or from AI-based interpolation algorithms of the pixel values in the baseline image. Thus, dark pixels of the normalized baseline image contain values smaller than 1, which after the pixel-wise division will lead to the corresponding pixels in the at least one digital output image being brighter than in the at least one digital input image.

The subtraction of the baseline image from the input image data, which is the above-mentioned alternative to the division, may be carried out by adding the inverse of the baseline image to the input image data:

$$O ( {X}_{i} ) = I ( {X}_{i} ) \cdot {F}_{b}^{- 1} ( {X}_{i} )$$

Alternatively, a pixel-wise subtraction may be employed:

$${O}_{{x}_{i}} = {I}_{{x}_{i}} - {F}_{b , {x}_{i}}$$

As already described above, this will result in a homogenization of brightness, since bright regions of the at least one digital input image become darker in the at least one digital output image. Optionally, the maximal intensity value of the baseline image may be added after the pixel-wise subtraction to the entire digital output image in order to increase the overall brightness of the at least one digital output image.

The shading correction produces good results, if the length threshold value depends on a size of the at least one digital input image. For example, the device may be configured to calculate the length threshold value based on the image size. In particular, the length threshold value may be proportional to the image size. Preferably, the length threshold value is 5%, more preferably 10%, most preferably 20% of the image size, wherein the image size is a width of the at least on digital input image measured in pixel or length units in one of the image directions.

As briefly mentioned above, the baseline image can be computed using a fit to the input image data e.g., a polynomial fit or a spline fit. For this purpose, the device may be configured to compute the baseline image using the fit to the input image data, and wherein the fit is calculated by an iterative minimization scheme. Advantageously, the use of an iterative minimization scheme facilitates the implementation in comparison to an analytic approach.

Optionally, the iterative minimization scheme may comprise a least-square minimization criterion, which is to be minimized for the fit. Thus, the iterative minimization scheme has a concretely defined objective function. The least-square minimization criterion may comprise a penalty term and a cost function. In particular, the least-square minimization criterion M(F_{b}(Xᵢ)) may have the following form:

$$M ( {F}_{b} ( {X}_{i} ) ) = P ( {F}_{b} ( {X}_{i} ) ) + C ( {F}_{b} ( {X}_{i} ) )$$

where P(F_{b}(Xᵢ)) is the penalty term and C(F_{b}(Xᵢ)) is the cost function, as will be explained below.

The least-square minimization criterion may comprise the penalty term P(F_{b}(Xᵢ)), in order to ensure that the baseline image data F_{b}(Xᵢ) are an accurate representation of only the shading signal and to avoid that the baseline image data are fitted to the content signal. In particular, the penalty term may take any form that introduces a penalty if the baseline image data are fitted to data that are considered to belong to the content signal. Such a penalty may be created by increasing the penalty term in value if the content signal is represented in the baseline image data.

Under the assumption that the shading signal has a low spatial frequency, the penalty term may be a term that becomes large if the spatial frequency of the baseline image becomes large. Such a term may be in one embodiment a roughness penalty term, which penalizes non-smooth baseline image data that deviate from a smooth baseline. Such a roughness penalty term effectively penalizes the fitting of data having high spatial frequency.

For example, a deviation from a smooth baseline may lead to large values in at least one of the first derivative, i.e. the steepness or gradient, and the second derivative, i.e. the curvature, of the baseline image data. Therefore, the roughness penalty term may contain at least one of a first spatial derivative of the baseline image, in particular the square and/or absolute value of the first spatial derivative, and a second derivative of the baseline image, in particular the square and/or absolute value of the second spatial derivative. Generally, the penalty term may contain a spatial derivative of any arbitrary order of the baseline image represented by the baseline image data. More generally, the penalty term may contain any linear combination of spatial derivatives of the baseline image data representing the baseline image.

Without loss of generality, the penalty term P(F_{b}(Xᵢ)) may have the following form for the one-dimensional case, for example:

$$P ( {F}_{b} ( {X}_{i} ) ) = r {\sum }_{i = 1}^{m} {( \partial {F}_{b} ( {X}_{i} ) )}^{2}$$

where r is a regularization parameter and ∂ is a discrete operator for computing the first derivative. The utility of the regularization parameter r is explained further below.

More generally, the penalty term P(F_{b}(Xᵢ)) may have the form:

$$P ( {F}_{b} ( {X}_{i} ) ) = r {\sum }_{i = 1}^{m} {( {\partial }^{j} {F}_{b} ( {X}_{i} ) )}^{2}$$

where ∂^{j} is a discrete operator for computing the j-th derivative. For multidimensional digital input images, different penalty terms P(F_{b}(Xᵢ)) may be used in the different dimensions.

The regularization parameter r serves as a multiplicative weighing factor in the penalty term. As such, the units of the regularization parameter r may be chosen such that the penalty term results in a scalar, dimensionless quantity. Further, the regularization parameter r may be chosen based on the length threshold value. For example, the regularization parameter r may be equal to the above-mention threshold length λ:

r=λ

For a large length threshold value, the penalty term is amplified by the weighing factor. Conversely, for a small length threshold value, the effect of the penalty term is attenuated by the weighing factor. Due to amplification and attenuation of the penalty term, the resulting baseline image is forced to be smoother in the former case, while having a certain roughness in the latter.

Additionally or alternatively, the length threshold value may be included in the penalty term as an additive weighing constant.

Instead of the multiplicative weighing factor or the additive weighing constant, the length threshold value may also be used for selecting an optimal polynomial order K that is used for the above-mentioned polynomial fit. That is, the baseline image data may be represented by the K-order polynomial in any of the n dimensions i:

$${F}_{b} ( {X}_{i} ) = {\sum }_{k = 0}^{K} {a}_{i , k} {X}_{i}^{k}$$

where a_{i,k} are the coefficients of the polynomial in the i-th dimension. For each dimension i=1, . . . , n, a separate polynomial may be computed. The optimum value for the maximum polynomial order K depends on the required smoothness of the baseline image data. For a smooth baseline (i.e. large length threshold value), the polynomial order K must be set as low as possible, whereas fitting a highly irregular background (i.e. small length threshold value) may require a higher order K.

In the case of a polynomial fit, the baseline image data may consist only of the polynomial coefficients a_{i,k} or of intensity data representing the graph of the K-order polynomial.

The least-square minimization criterion may further comprise the cost function C(F_{b}(Xᵢ), which represents a difference between the input image data I(Xᵢ) and the baseline image represented by the baseline image data F_{b}(Xᵢ). An example of a cost function for the one-dimensional case is:

$$C ( {F}_{b} ( {X}_{i} ) = ‖ I ( {X}_{i} ) - {F}_{b} ( {X}_{i} ) ‖$$

where ∥ . . . ∥ denotes the L₁-Norm i.e., the sum of absolute values. For the multidimensional case, the sum of the root-mean-square values across all dimensions of the sum of squared differences between the input image data and the baseline image data in the i-th dimension may be used instead of the L₁-Norm.

The shading signal normally does not contain high peaks, whereas the content signal can very well contain high peaks. Therefore, the cost function C(F_{b}(Xᵢ)) may be a truncated difference term in order to avoid that the baseline image data are fitted to the content signal. To implement this, the data processing device may be configured to obtain e.g., from external user input, a predetermined peak threshold value s, which is larger than zero and defines at what peak height the difference term is to be truncated.

The truncated difference term may be symmetric or asymmetric. Preferably, the truncated difference term may be a truncated quadratic term representing the difference between the input image data I(Xᵢ) and the baseline image data F_{b}(Xᵢ), wherein the output value of the truncated quadratic term is limited to a constant value, if the difference between the input image data and the baseline image data is larger than the peak threshold value s. Otherwise, the value of the truncated quadratic term is equal to the square of the difference between the input image data and the baseline image data. Thus, the baseline image data will follow high intensity peaks of the content signal only to a limited amount and shallow intensity peaks of the shading signal all the more. The truncated quadratic term φ(F_{b}(Xᵢ)) may be of the form:

$$φ ( {F}_{b} ( {X}_{i} ) ) = \{ \begin{matrix}{( I ( {X}_{i} ) - {F}_{b} ( {X}_{i} ) )}^{2} if I ( {X}_{i} ) - {F}_{b} ( {X}_{i} ) \leq s \\ {s}^{2} else\end{matrix}$$

Using the truncated quadratic term φ(F_{b}(Xᵢ)), the cost function C(F_{b}(Xᵢ)) may be expressed as:

$$C ( {F}_{b} ( {X}_{i} ) ) = {\sum }_{i = 1}^{m} φ ( {F}_{b} ( {X}_{i} ) )$$

Optionally, the above-mentioned iterative minimization scheme may comprise a first iterative stage and a second iterative stage, the first and second iterative stages together representing one iteration step or iteration cycle.

For example, the data processing device may be configured to compute the baseline image using an iterative half-quadratic minimization scheme aimed at minimizing the least-square minimization criterion. The half-quadratic minimization scheme may e.g. comprise at least part of the LEGEND algorithm, which is computationally efficient. The LEGEND algorithm is described in Idier, J. (2001): Convex Half-Quadratic Criteria and Interacting Variables for Image Restoration, IEEE Transactions on Image Processing, 10(7), p. 1001-1009, and in Mazet, V., Carteret, C., Bire, D, Idier, J., and Humbert, B. (2005): Background Removal from Spectra by Designing and Minimizing a Non-Quadratic Cost Function, Chemometrics and Intelligent Laboratory Systems, 76, p. 121-133. Both articles are herewith incorporated by reference in their entirety.

The LEGEND algorithm introduces discrete auxiliary data Dₗ(xᵢ) that are preferably of the same dimensionality as the input image data I(Xᵢ). These auxiliary data are updated in each iteration cycle, preferably in the first iterative stage, based on the input image data and the latest baseline image data representing the baseline image. In particular, the auxiliary data are updated using a variation of the truncated quadratic term as follows:

$${D}_{l} ( {X}_{i} ) = \{ \begin{matrix}( 2 α ) - 1 ) {( I ( {X}_{i} ) - {F}_{b , l - 1} ( {X}_{i} ) )}^{2} if I ( {X}_{i} ) - {F}_{b , l - 1} ( {X}_{i} ) \leq s \\ - I ( {X}_{i} ) + {F}_{b , l - 1} ( {X}_{i} ) else\end{matrix}$$

where l=1 . . . L is the index of the current iteration cycle and a is a constant value e.g., 0.493.

In the second iterative stage, the baseline image data may be updated based on the previously calculated, updated auxiliary data, the baseline image data from the previous iteration cycle and the penalty term using the following formula:

$${F}_{b , l} ( {X}_{i} ) = {argmin}_{{F}_{b}} [ {‖ I ( {X}_{i} ) - {F}_{b , l - 1} ( {X}_{i} ) + {D}_{l} ( {X}_{i} ) ‖}^{2} + P ( {F}_{b} ( {X}_{i} ) ]$$

Alternatively, the baseline image data representing the baseline image are computed using a convolution of a discrete Green's function G(Xᵢ) with a sum of the input image data I(Xᵢ) and the updated auxiliary data Dₗ(Xᵢ), in this second iterative stage. In other words, the second iterative stage of the LEGEND algorithm may be replaced by the following iterative step, where the updated baseline image data F_{b,1}(Xᵢ) are computed in the l-th iteration cycle using the Green's function G(Xᵢ):

$${F}_{b , l} ( {X}_{i} ) = G ( {X}_{i} ) * ( I ( {X}_{i} ) + {D}_{l} ( {X}_{i} ) )$$

Without loss of generality, the Green's function G(Xᵢ) may have the following form for the one-dimensional case:

$$G ( {X}_{i} ) = {ℱ}^{- 1} [ \frac{1}{1 - r \cdot ℱ [ \frac{\partial P ( {F}_{b} ( {X}_{i} )}{\partial {F}_{b} ( {X}_{i} )} ]} ]$$

where [symbol] [ . . . ] is the discrete Fourier transform, [symbol] ⁻¹[ . . . ] is the inverse discrete Fourier transform, r is the regularization parameter, and

$$\frac{\partial }{\partial }$$

the functional derivative.

This step reduces the computational burden significantly as compared to the traditional LEGEND algorithm. The reduced computational burden results from the fact that a convolution is computed. This computation can be efficiently carried out using an FFT algorithm. Moreover, the second iterative step may make full use of an array processor, such as a graphics processing unit (GPU) or an FPGA due to the FFT algorithm.

As a starting step in the iterative minimization scheme, an initial set of baseline image data (e.g. F_{b,1}(Xᵢ)=I(Xᵢ)) and an initial set of auxiliary data (e.g. D₁(Xᵢ)=0) can be defined. The first and second iterative stages are then preferably repeated until a convergence criterion is met. A suitable convergence criterion may be, for example that the sum of the differences between the current baseline image data and the previous baseline image data across all locations Xᵢ is smaller than a predetermined convergence threshold value.

The computation of the baseline image itself is not limited to the procedures described above and can be accomplished by virtually any known method for estimating a baseline that correctly represents the shading signal of a given digital image.

According to one possible embodiment of the data processing device, the input image data may represent multiple digital input images. Herein, each individual digital input image is represented by a different subset of the input image data. In particular, the multiple digital input images may be part of a tile-scan and/or a Z-stack. In a tile-scan, a plurality of images showing neighboring areas are stitched together. The shading effect in each of the images produces a checkerboard pattern that can be seen in the overlap regions making the image look unprofessional or unusable for publication. In a Z-stack, a plurality of images showing different layers of a sample are stacked. Since each image is taken with different objective and/or illumination settings, each layer shows a slightly different shading effect.

Advantageously, the data processing device allows shading correction for both cases when the device is configured to compute the baseline image for each of the multiple digital input images, and to calculate an averaged baseline image based on the baseline images of the multiple digital input images. The averaged baseline image may be calculated as an arithmetic, geometric or quadratic mean, as the median, from an interpolation of the baseline images of the multiple digital input images. Averaging makes the data processing device less prone to outliers.

Further, the data processing device may be configured to generate multiple digital output images by at least one of a) subtracting the averaged baseline image from the input image data and b) dividing the input image data by the averaged baseline image. In particular, one output image is generated for each of the multiple digital input images. The generation of the output images can be implemented as multiple image-wise subtractions/divisions or as one subtraction/division operation that is applied to the entire input image data. In the prior case, each subset of the input image data is subtracted/divided by the same baseline image. In the latter case, the averaged baseline image is duplicated for each subset. The duplicates are stitched together if a tile-scan is concerned or stacked if a Z-stack is concerned.

According to another embodiment, the device may be configured to first calculate averaged input image data from the multiple digital input images, before computing an average baseline image based on the averaged input image data and the length threshold value. The averaged input image data may be image data that represent the median, an interpolation, an arithmetic mean, a geometric mean or a quadratic mean of the multiple digital input images. The multiple digital output images may then be generated by at least one of a) subtracting the averaged baseline image from the input image data and b) dividing the input image data by the averaged baseline image. This embodiment requires a lower number of total calculation steps, since the baseline image is only computed once in the form of the averaged baseline image.

According to another aspect, the data processing device may comprise a microprocessor or may be configured as a microprocessor or as part of such microprocessor. The data processing device and/or the microprocessor may comprise a memory as a combination of read-only memory (ROM) with any arbitrary amount of random access memory (RAM).

Alternatively, the data processing device may be part of a computer that is separated from the imaging apparatus. In particular, the data processing device as well as the computer implemented method may be implemented in a personal computer, a single-board computer and/or a cloud computing network.

The data processing device may also be an embedded processor. Embedded processors being a class of small-sized computers or computer chips, can be embedded in various machines and devices to control electrical and mechanical functions there.

Alternatively, the data processing device may be only part of such an embedded processor. This also allows the data processing device to be integrated into an imaging apparatus requiring the computation of baseline images.

In particular, the embedded processor may be an embedded processor for/of a microscope, in particular a confocal microscope, a light sheet microscope or a fluorescence microscope. Advantageously, the inventive concept may thus be utilized in the field of microscopy.

Consequently, the initial object is also achieved by a microscope and any other kind of imaging apparatus comprising a data processing device according to one of the above-described embodiments, wherein the imaging apparatus is configured to record the input image data representing the at least one digital input image. Besides the microscope, the imaging apparatus may also be an endoscope, a scanner, a camera, a photon counter and/or a photon detector.

The imaging apparatus benefits from the advantages described above of the data processing device. In particular, the computation of the baseline image may be performed in real time or retroactively depending on the needs of the user.

Likewise, the initial object is achieved by a method for operating an imaging apparatus, the method comprising the steps of recording input image data representing at least one digital input image, and carrying out the computer-implemented method. As a result, at least one shading corrected output image can be obtained with little effort.

According to another aspect, the inventive method may be adapted to operate a data processing device according to any one of the embodiments described above. Advantageously, this allows the inventive method to be carried out on hardware that is specifically dedicated to a specific purpose. In particular, the inventive method may be executed on an embedded processor of a microscope.

Alternatively, the inventive method may also be adapted to operate a general-purpose computer. Thereby, the applicability of the inventive method is improved. Accordingly, the initial object is achieved by a computer-program product comprising a program code which, when executed by a computer, such as a general-purpose computer, causes the computer to carry out the inventive method. Likewise, the initial object is also achieved by a computer-readable medium comprising a program code which, when executed by the computer, causes the computer to carry out the inventive method. Both the computer-program product and the computer-readable medium are advantageous and achieve the initial object, since they represent means for carrying out the inventive method.

The at least one digital output image does not necessarily have to be the end result for the user. For example, the shading correction according to the present invention may be used as a pre-processing step. That is, further data processing steps, such as image deblurring may be carried out on the at least one digital output image. In particular, a different length threshold value may be used for computing a further baseline image to approximate an out-of-focus component I_{out-of-focus} in the content signal as described in European Patent EP 3 571 663 B1, which is herewith incorporated by reference in its entirety.

The resulting final image may then be calculated as:

$$\frac{I ( {X}_{i} )}{{F}_{b} ( {X}_{i} )} - {I}_{out - of - focus} ( {X}_{i} )$$

The initial object of the present invention is further achieved by a neural network device trained by a plurality of digital input images and a plurality of digital output images, where the digital output images are computed from the digital input images with the data processing device or by the computer implemented method. As such, the neural network device is capable of generating a digital output image based on a digital input image. Advantageously, the neural network device emulates the computations of the data processing device or the computer-implemented method due to its training by the pairs of different digital input images and digital output images.

A training method for a neural network device by pairs of different digital input images and digital output images also achieves the initial object, where the digital output images are computed from the digital input images with the data processing device or by the computer-implemented method. The training method is advantageous, as it allows creating neural network devices having the characteristics mentioned above.

The data processing device and each of its functions may be implemented in hardware, in software or as a combination or hardware and software. For example, at least one function of the data processing device may at least partly be implemented by a subroutine, a section of a general-purpose processor, such as a CPU, and/or a dedicated processor such as a GPU, FPGA, vector processor and/or ASIC.

### BRIEF DESCRIPTION OF THE FIGURES

The invention will now be described by way of example using sample embodiments, which are also shown in the drawings. In the drawings, the same reference numerals are used for features which correspond to each other with respect to at least function and/or design.

The combination of features shown in the enclosed embodiments is for explanatory purposes only and can be modified. For example, a feature of the embodiments having a technical effect that is not needed for a specific application may be omitted. Likewise, a feature which is not shown to be part of the embodiment may be added if the technical effect associated with this feature is needed for a particular application.

FIG. 1: shows a schematic representation of an imaging apparatus with a data processing device according to an exemplary embodiment of the present invention;

FIG. 2: shows schematic representations of an exemplary input image, an exemplary baseline image and an exemplary output image;

FIG. 3: shows a schematic graphical representation of computation steps;

FIG. 4: shows a schematic representation of the imaging apparatus with the data processing device according to another exemplary embodiment;

FIG. 5: shows a schematic representation of a flowchart for a computer implemented method according to an exemplary embodiment of the present invention;

FIG. 6: shows a schematic representation of the imaging apparatus with the data processing device according to another exemplary embodiment; and

FIG. 7: shows schematic representations of exemplary input images and exemplary output images.

### DETAILED DESCRIPTION

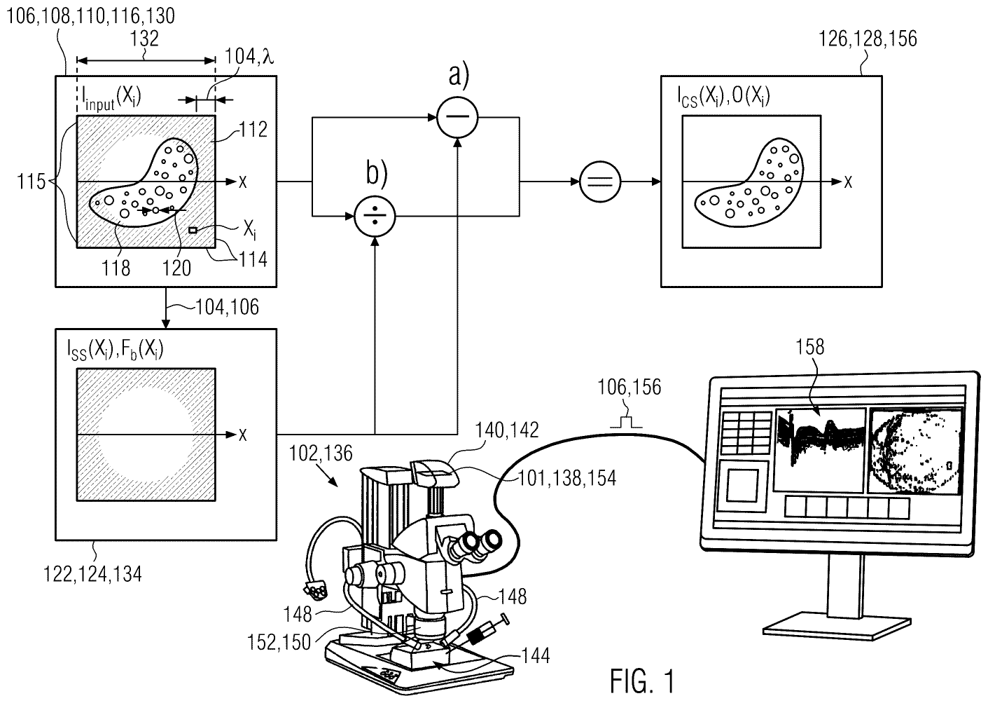

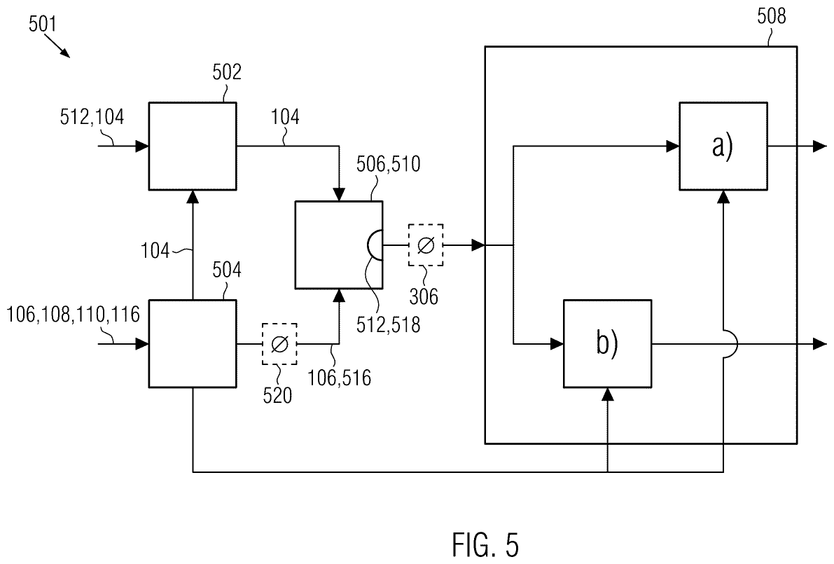

First, the structure and functionality of a data processing device 101 is explained with reference to FIGS. 1 to 4, 6 and 7. Thereafter, the computer-implemented method 501 is described with reference to FIG. 5.

The data processing device 101 may be part of an imaging apparatus 102, such as a microscope 136, an endoscope (not shown), a scanner 401, a camera (not shown), a photon counter 606 or any other type of scientific or medical observation device. The following description will focus on the microscope 136, but applies to the other types of imaging apparatus 102 as well.

The data processing device 101 may be integrated in the microscope 136 as an embedded processor 138 or as part of such an embedded processor 138. Further, the microscope 136 may comprise an image-forming section 140, which is adapted to capture with a microscope camera 142, a digital input image 108 in the form of input image data 106. In particular, the digital input image 108 may comprise the input image data 106 at a number of input image locations m, such as pixels or voxels. The input image data 106 may be discrete intensity data and/or discrete color data for example. The input image data 106 are preferably represented by an n-dimensional array I(Xᵢ), where n is an integer equal to or larger than 1.

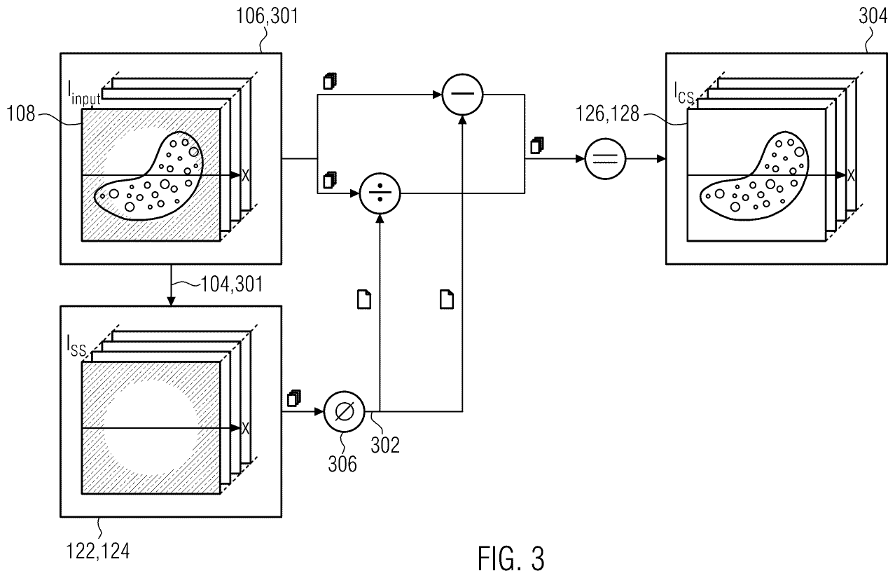

Optionally, the microscope camera 142 may capture multiple digital input images 301 in the form of the input image data 106 (see FIG. 3). It is to be understood that the input image data 106 can be captured by any kind of microscope, in particular with a fluorescence light microscope operable in a widefield mode and/or using a confocal laser-scanning microscope.

The microscope camera 142 may record the input image data 106 in monochrome. Alternatively, the microscope camera 142 may be a CCD, multispectral or hyperspectral camera, which records the input image data 106 in a plurality of channels, wherein each channel preferably represents a different light spectrum range from the infrared to the ultraviolet. In the case of a CCD camera, three channels, e.g. an R-channel, a G-channel and a B-channel may be provided to represent the digital input image 108 as a visible light image of an object 144, such as a sample 146. In the case of a multi or hyperspectral camera, a total of more than three channels may be used in at least one of the visible light range, the IR light range, the NIR light range and the ultraviolet light range.

The object 144 may comprise animate and/or inanimate matter. The object 144 may further comprise one or more fluorescent materials, such as at least one fluorophore. A multispectral or hyperspectral camera may have one channel for each different fluorescence spectrum of the fluorescent materials in the object 144. For example, each fluorophore may be represented by at least one channel, which is matched to the fluorescence spectrum triggered by an illumination 148. The microscope 136 may be adapted to excite fluorescence e.g. of fluorophores within the object 144 with light having a suitable fluorescence excitation wavelength by the illumination 148. Alternatively or additionally, channels may be provided for auto-fluorescence spectra or for spectra of secondary fluorescence, which is triggered by fluorescence excited by the illumination 148 or for lifetime fluorescence data. Of course, the illumination 148 may also or solely emit white light or any other composition of light without triggering fluorescence in the object 144.

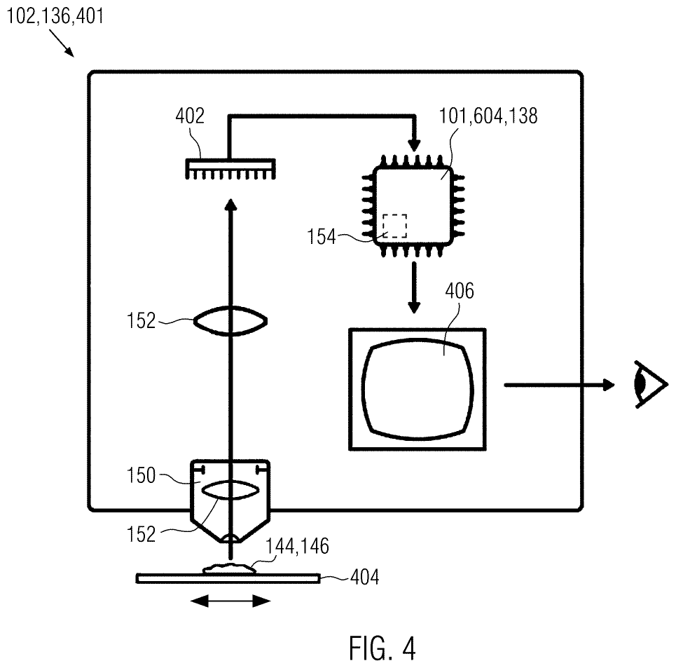

The microscope 136 may comprise an optical objective 150 with at least one lens 152. Light guided through the at least one lens 152 is directed to an image sensor 402, through which the input image data 106 are acquired (see FIG. 4). The illumination 148 may comprise or consist of one or more flexible light guides to direct light onto the object 144 from one or more different directions. A suitable blocking filter (not shown) may be arranged in the light path in front of the microscope camera 142, e.g. to suppress glare. For fluorescence imaging, a blocking filter preferably blocks only the illumination wavelength and allows the fluorescent light of the fluorophores in the object 144 to pass to the microscope camera 142.

The input image data 106 may be one-dimensional if a line camera is used for the recording. Alternatively, the input image data 106 are two-dimensional if a single channel is contained in a two-dimensional image. The digital input image may have a higher dimensionality than two if more than one channel is comprised and/or if the input image data 106 represent a three-dimensional image.

Three-dimensional input image data 106 may be recorded by the microscope 136 by e.g. using light-field technology, Z-stacking in microscopes, images obtained by a SCAPE microscope and/or a three-dimensional reconstruction of images obtained by a SPIM microscope. In the case of a three-dimensional image, each plane of the three-dimensional input image data 106 may be considered as a two-dimensional digital input image 108. Again, each plane may comprise several channels. Each channel may be regarded as a separate two-dimensional image. Alternatively, a plurality of channels may be interpreted together as a multi-dimensional array.

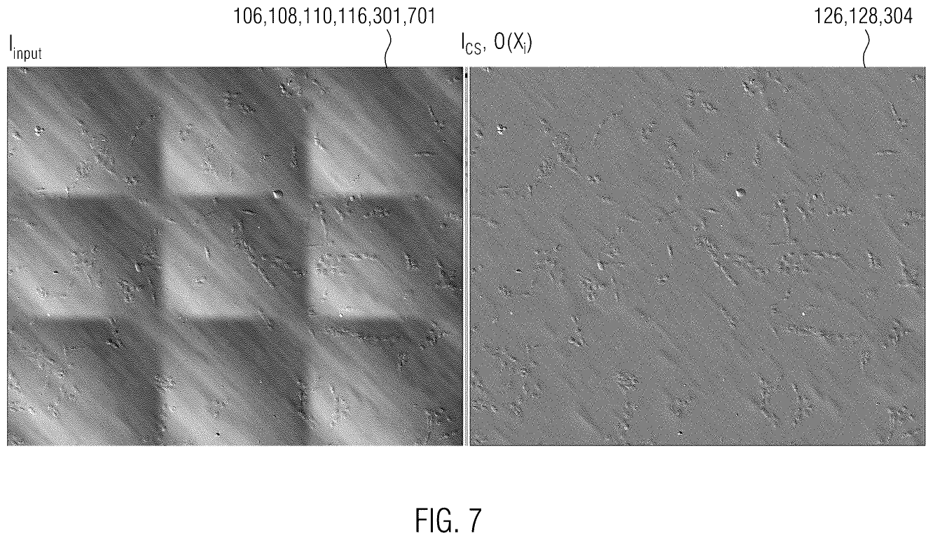

The microscope 136 shown in FIG. 4 comprises the elements/components shown therein. The microscope 136 can be regarded as a device for imaging the object 144 being located on an object slide 404. The object slide 404 may be movable with respect to the microscope 136. Thereby, the object 144 may be scanned by capturing a plurality of digital input images 301 showing mutually neighboring areas of the object 144. The plurality of digital input images 301 may be stitched together to a tile-scan 701 (see FIG. 7).

The microscope 136, in particular the data processing device 101 may further comprise an image storage section 154 adapted to contain, at least temporarily, the input image data 106. The data processing device 101 may also be part of a computer 608, such as a general-purpose computer, in particular a workstation 610 of the microscope 136 comprising the image storage section 154. The image storage section 154 may comprise a volatile or non-volatile memory, such as a cache memory of a CPU of the computer 608, and/or of a GPU of the computer 608. The image storage section 154 may further comprise RAM, a hard disk drive or an exchangeable storage system, such as a USB stick or an SD card. The image storage section 154 may comprise any combination of these types of memory.

As can be seen in FIGS. 1, 2 and 7, the digital input image 108 contains image features 118 that represent the actual content of interest for the user. Each image feature 118 extends along a certain length 120 that is larger than zero. The length 120 may be a number of length units or a number of pixels in one direction.

As can also be observed in FIGS. 1, 2 and 7, the digital input image 108 is further subject to a so-called shading effect. In particular, the at least one lens 152 may cause lens vignetting, resulting in a gradual decrease in brightness towards the image periphery of the digital input image 108, i.e. towards the edges 114 and corners 115 of the digital input image 108. This brightness decrease 112 instead may be caused or further amplified by inhomogeneities in the illumination 148. In any case, the brightness decrease 112 tends to follow a certain pattern e.g., having a brighter center and darker edges. In the tile-scan 701, the shading effect produces a clearly perceivable checkerboard pattern (see FIG. 7).

Thus, the input image data 106 representing the digital input image 108 may be assumed to comprise a shading signal 110 representing the brightness decrease 112 due to the shading effect and a content signal 116 representing the image features 118.

The data processing device 101 primarily serves for generating a digital output image 126 in which the shading effect is minimized or at least mitigated. For this purpose, the device 101 is configured to access the input image data 106 and carry out a shading correction as follows:

The shading correction is exemplarily described for applications, where the pattern of the brightness decrease 112 spreads over a larger distance than the lengths 120 of the image features 118. Under this assumption, the content signal 116 may be assumed to exhibit a high spatial frequency e.g. being responsible for intensity and/or color changes that take place over a short distance in the digital input image 108, while the shading signal 110 is assumed to exhibit a low spatial frequency, i.e. leading to predominantly gradual intensity and/or color changes that extend over comparatively large regions of the digital input image 108.

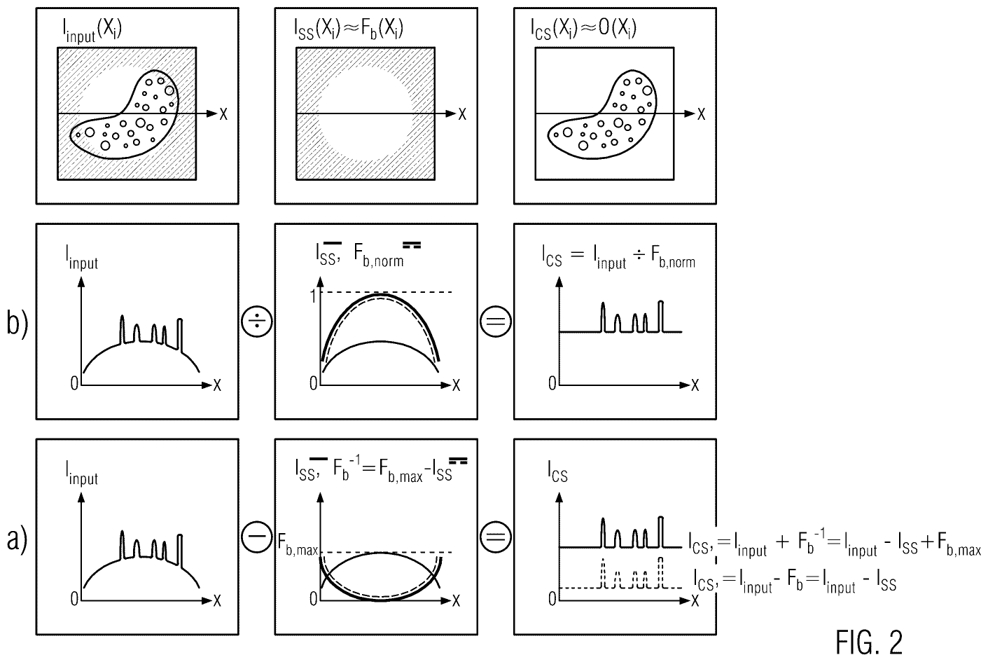

Due to its low spatial frequency, the shading signal 110 (i.e. brightness decrease 112) can be considered as a more or less smooth baseline which is overlaid with the content signal 116 having high spatial frequency. This is illustrated in FIG. 2, where the shading signal 110 is denoted as I_{SS}(Xᵢ) and the content signal 116 is denoted as I_{CS}(Xᵢ).

The data processing device 101 is configured to compute a baseline image 122 that is an estimate of said baseline in the intensity data and/or color data. As such, the baseline image 122 is also representative of an estimate of the shading signal 110. In simpler terms, the baseline image 122 is supposed to be a rough “brightness map” for identifying which part of the digital input image 108 is unduly dark as a result of the shading effect.

The baseline image 122 is preferably represented by discrete baseline image data at a number of baseline image locations, such as pixels or voxels. Therefore, the baseline image data F_{b}(Xᵢ) represent an approximation of the shading signal I_{SS}(Xᵢ). The baseline image data may be an n-dimensional array F_{b}(Xᵢ) having the same dimensionality as the input image data I(Xᵢ).

The baseline image 122 is computed based on the input image data 106 and a length threshold value 104 that is considered to be larger than the length of the biggest or average image feature 118 For this purpose, the data processing device 101 is configured to obtain the length threshold value 104. This will be described in detail further below.

Once the baseline image 122 is computed, the device 101 is configured to generate the digital output image 126 by removing the shading signal 110 front the input image data 106 and thereby effectively extracting the content signal 116. This is done by at least one of a) subtracting the baseline image 122 from the input image data 106 and b) dividing the input image data 106 by the baseline image 122. The resulting digital output image 126 is then representative of an estimate of the content signal 116. The digital output image 126 may comprise output image data 156 represented by an n-dimensional array O(Xᵢ) at a number of output image locations, such as pixels or voxels. The output image data O(Xᵢ) represent an approximation of the content signal I_{CS}(Xᵢ).

This shading correction may also be carried out as the computer-implemented method 501 on the computer 608. Therefore, a computer program 601 comprising a program code 612 which, when executed by the computer 608, causes the computer 608 to carry out the method 501 may be provided. Accordingly, a computer-readable medium 602 comprising the program code 612 may also be provided. In this case, the data processing device 101 may serve as an image processor, which is configured to read out the input image data 106 from the image storage section 154 or from an external image-forming section (e.g. the image-forming section 140 of the microscope 136). For this, the computer 608 may comprise an image input section 614.

Further details of the inventive aspects are described below with respect to the computer-implemented method 501. It is to be understood that the data processing device 101 may be configured to carry out said computer implemented method 501 accordingly.

As can be seen in FIG. 5, the method comprises the step 502 of obtaining the length threshold value 104. The length threshold value 104 can be obtained for example as a predetermined threshold length λ from direct user input 512. Alternatively, the length threshold value 104 can be obtained calculatively. In particular, the length threshold value 104 may depend on a size 132 of the digital input image 108. For example, the device 101 may be configured to calculate the length threshold value 104 based on the image size 132. In particular, the length threshold value 104 may be proportional to the image size 132. Preferably, the length threshold value 104 given as the as predetermined threshold length λ amounts to 5%, more preferably 10%, most preferably 20% of the image size 132, wherein the image size 132 is a width of the digital input image 108 measured in pixel or length units in one of the image directions.

Before, after or parallel to the step 502, accessing the input image data 106 takes place in step 504. The accessed input image data 106 may be recorded by the imaging apparatus 102 in real-time. Alternatively, the accessed input image data 106 can be retrieved, received or read out from the image storage section 154.

If the input image data 106 contain multiple digital input images 301, an optional step 520 may be carried out, where averaged input image data 516 are calculated from the multiple digital input images 301. The averaged input image data 516 may be image data that represent the median, an interpolation, an arithmetic mean, a geometric mean or a quadratic mean of the multiple digital input images 301.

The length threshold value 104 and the input image data 106 are then used in step 506 for computing the baseline image 122. In particular, the baseline image 122 can be computed using a fit to the input image data 106 e.g., a polynomial fit or a spline fit. Preferably, the fit is calculated by an iterative minimization scheme 510.

Optionally, the iterative minimization scheme 510 may comprise a least-square minimization criterion 512, which is to be minimized for the fit. The least-square minimization criterion 512 may comprise a penalty term and a cost function. In particular, the least-square minimization criterion 512 may be denoted as M(F_{b}(Xᵢ)) and have the following form:

$$M ( {F}_{b} ( {X}_{i} ) ) = P ( {F}_{b} ( {X}_{i} ) ) + C ( {F}_{b} ( {X}_{i} ) )$$

where P(F_{b}(Xᵢ)) is the penalty term and C(F_{b}(Xᵢ)) is the cost function.

Without loss of generality, the penalty term P(F_{b}(Xᵢ)) may have the following general form for the one-dimensional case for example:

$$P ( {F}_{b} ( {X}_{i} ) ) = r {\sum }_{i = 1}^{m} {( {\partial }^{j} {F}_{b} ( {X}_{i} ) )}^{2}$$

Where r is a regularization parameter and di is a discrete operator for computing the j-th derivative. For multidimensional digital input images, different penalty terms P(F_{b}(Xᵢ)) may be used in the different dimensions.

The regularization parameter r serves as a multiplicative weighing factor in the penalty term. As such, the units of the regularization parameter r may be chosen so that the penalty term results in a scalar, dimensionless quantity. Further, the regularization parameter r may be chosen based on the length threshold value 104. For example, the regularization parameter r may be equal to the above-mention threshold length λ:

r=λ

The least-square minimization criterion may further comprise the cost function C(F_{b}(Xᵢ), which represents a difference between the input image data I(Xᵢ) and the baseline image represented by the baseline image data F_{b}(Xᵢ). In particular, the cost function C(F_{b}(Xᵢ) may be a truncated difference term utilizing a predetermined peak threshold value s, which is larger than zero and defines at what peak height the difference term is to be truncated. The peak threshold value s may be obtained e.g., from external user input.

The truncated difference term may be symmetric or asymmetric. Preferably, the truncated difference term may be a truncated quadratic term representing the difference between the input image data I(Xᵢ) and the baseline image data F_{b}(Xᵢ), wherein the output value of the truncated quadratic term is limited to a constant value, if the difference between the input image data and the baseline image data is larger than the peak threshold value s. Otherwise, the value of the truncated quadratic term is equal to the square of the difference between the input image data and the baseline image data. The truncated quadratic term φ(F_{b}(Xᵢ)) may be of the form:

$$φ ( {F}_{b} ( {X}_{i} ) ) = \{ \begin{matrix}{( I ( {X}_{i} ) - {F}_{b} ( {X}_{i} ) )}^{2} if I ( {X}_{i} ) - {F}_{b} ( {X}_{i} ) \leq s \\ {s}^{2} else\end{matrix}$$

Using the truncated quadratic term φ(F_{b}(Xᵢ)), the cost function C(F_{b}(Xᵢ)) may be expressed as:

$$C ( {F}_{b} ( {X}_{i} ) ) = {\sum }_{i = 1}^{m} φ ( {F}_{b} ( {X}_{i} ) )$$

Optionally, the iterative minimization scheme 510 may be a half-quadratic minimization scheme comprising at least part of the LEGEND algorithm described in Idier, J. (2001): Convex Half-Quadratic Criteria and Interacting Variables for Image Restoration, IEEE Transactions on Image Processing, 10(7), p. 1001-1009, and in Mazet, V., Carteret, C., Bire, D, Idier, J., and Humbert, B. (2005): Background Removal from Spectra by Designing and Minimizing a Non-Quadratic Cost Function, Chemometrics and Intelligent Laboratory Systems, 76, p. 121-133. Herewith, both articles are incorporated by reference in their entirety.

The half-quadratic minimization scheme according to the LEGEND algorithm is aimed at minimizing the least-square minimization criterion 512 and utilizes discrete auxiliary data Dₗ(xᵢ) that are preferably of the same dimensionality as the input image data I(Xᵢ). As a starting step in the half-quadratic minimization scheme, an initial set of baseline image data (e.g. F_{b,1}(Xᵢ)=I(Xᵢ)) and an initial set of auxiliary data (e.g. D₁(Xᵢ)=0) can be defined.

Moreover, the half-quadratic minimization scheme may comprise a first iterative stage and a second iterative stage, the first and second iterative stages together representing one iteration step or iteration cycle. The first and second iterative stages are then preferably repeated until a convergence criterion 518 is met. A suitable convergence criterion 518 may be, for example that the square sum of the differences between the current baseline image data and the previous baseline image data across all locations Xᵢ is smaller than a predetermined convergence threshold value c.

In the first iterative stage of each iteration cycle, the auxiliary data are updated based on the input image data and the latest baseline image data representing the baseline image. In particular, the auxiliary data are updated using a variation of the truncated quadratic term as follows:

$${D}_{l} ( {X}_{i} ) = \{ \begin{matrix}( 2 α - 1 ) {( I ( {X}_{i} ) - {F}_{b , l - 1} ( {X}_{i} ) )}^{2} if I ( {X}_{i} ) - {F}_{b , l - 1} ( {X}_{i} ) \leq s \\ - I ( {X}_{i} ) + {F}_{b , l - 1} ( {X}_{i} ) else\end{matrix}$$

where l=1 . . . L is the index of the current iteration cycle and a is a constant value e.g., 0.493.

In the second iterative stage, the baseline image data may be updated based on the previously calculated, updated auxiliary data, the baseline image data from the previous iteration cycle and the penalty term using the following formula:

$${F}_{b , l} ( {X}_{i} ) = {arg min}_{{F}_{b}} [ {‖ I ( {X}_{i} ) - {F}_{b , l - 1} ( {X}_{i} ) + {D}_{l} ( {X}_{i} ) ‖}^{2} + P ( {F}_{b} ( {X}_{i} ) ]$$

Alternatively, the baseline image data representing the baseline image are computed using a convolution of a discrete Green's function G(Xᵢ) with a sum of the input image data I(Xᵢ) and the updated auxiliary data Dₗ(Xᵢ), in the second iterative stage. In other words, the second iterative stage of the LEGEND algorithm may be replaced by the following iterative step, where the updated baseline image data F_{b,1}(Xᵢ) are computed in the l-th iteration cycle using the Green's function G(Xᵢ):

$${F}_{b , l} ( {X}_{i} ) = G ( {X}_{i} ) * ( I ( {X}_{i} ) + {D}_{l} ( {X}_{i} ) )$$

Without loss of generality, the Green's function G(Xᵢ) may have the following form for the one-dimensional case:

$$G ( {X}_{i} ) = {ℱ}^{- 1} [ \frac{1}{1 - r \cdot ℱ [ \frac{\partial P ( {F}_{b} ( {X}_{i} )}{\partial {F}_{b} ( {X}_{i} )} ]} ]$$

where [symbol] [ . . . ] is the discrete Fourier transform, [symbol] ⁻¹[ . . . ] is the inverse discrete Fourier transform, r is the regularization parameter, and

$$\frac{\partial }{\partial }$$

the functional derivative.

The computation of the baseline image itself is not limited to the procedures described above and can be accomplished by virtually any known method for estimating a baseline that correctly represents the shading signal of a given digital image.

If the optional step 520 was carried out beforehand, the averaged input image data 516 may be used instead of the input image data 106 for computing the baseline image 122. If the input image data 106 contain multiple digital input images 301, but the optional step 520 was not carried out, one baseline image 122 for each of the multiple digital input images 301 is computed. Thereafter an averaged baseline image 302 is calculated from all the baseline images 122 of the multiple digital input images 301 in a further optional step 306 (see also FIG. 3). The averaged baseline image 302 may be calculated as an arithmetic, geometric or quadratic mean, as the median, from an interpolation of the baseline images 122 of the multiple digital input images 301.

Next, in step 508, the digital output image represented by the output image data O(Xᵢ) can be generated a) subtractively or b) divisively as already mentioned above.

The subtraction of the baseline image from the input image data may be carried out by adding the inverse of the baseline image F_{b}⁻¹(Xᵢ) to the input image data I(Xᵢ), the inverse of the baseline image being for example an invert color image of the baseline image:

$$O ( {X}_{i} ) = I ( {X}_{i} ) + {F}_{b}^{- 1} ( {X}_{i} )$$

Alternatively, a pixel-wise subtraction may be employed:

$${O}_{{x}_{i}} = {I}_{{x}_{i}} - {F}_{b , {x}_{i}}$$

Optionally, the maximal intensity value F_{b,max} of the baseline image may be added after the pixel-wise subtraction to the entire digital output image in order to increase the overall brightness of the at least one digital output image (see FIG. 2).

Likewise, dividing the input image data I(Xᵢ) by the baseline image F_{b}(Xᵢ) may be carried out as a pixel-wise division for all pixels:

$${O}_{{x}_{i}} = {I}_{{x}_{i}} \div {F}_{b , {x}_{i}}$$

Optionally, the baseline image F_{b}(Xᵢ) may be normalized to 1 before the pixel-wise division.

That is, the brightest pixel of the baseline image may be given the value 1 in the normalized baseline image F_{b,norm}(Xᵢ).

F_{b,norm}(X_{i,max})=1

All values of the remaining pixels in the normalized baseline image F_{b,norm}(Xᵢ) may be obtained from a linear interpolation, a bilinear interpolation, a nearest-neighbor interpolation, a Lanczos interpolation or from AI-based interpolation algorithms of the pixel values in the baseline image F_{b},(Xᵢ). Thus, dark pixels of the normalized baseline image contain values smaller than 1, which after the pixel-wise division will lead to the corresponding pixels in the at least one digital output image being brighter than in the at least one digital input image (see FIG. 2).

Alternatively, a multiplication of the input image data I(Xᵢ) with the inverse of the baseline image F_{b}⁻¹(Xᵢ) may be employed:

$$O ( {X}_{i} ) = I ( {X}_{i} ) \cdot {F}_{b}^{- 1} ( {X}_{i} )$$

The microscope 136 of FIG. 4 comprises an integrated display 406 being adapted to display at least one of the digital input image 108, the baseline image 122 and the digital output image 126. Alternatively or additionally, an external monitor 158 may be provided for these displaying purposes.

In case the input image data 106 contain multiple digital input images 301, and if the above-mentioned averaged baseline image 302 was calculated in optional step 306, multiple digital output images 304 may be generated in step 508 by at least one of a) subtracting the averaged baseline image 302 from the input image data 106 and b) dividing the input image data 106 by the averaged baseline image 302 (see FIG. 3).

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

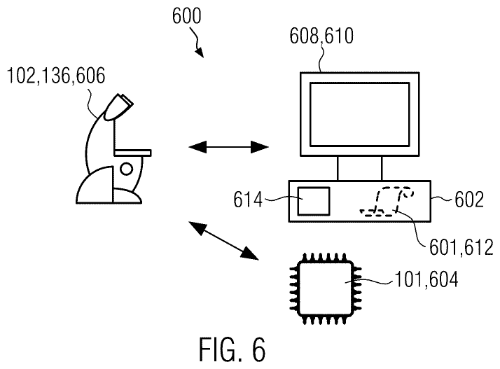

Some embodiments relate to a microscope 136 comprising a system as described in connection with one or more of the FIGS. 1 to 5. Alternatively, a microscope may be part of or connected to a system as described in connection with one or more of the FIGS. 1 to 5. FIG. 6 shows a schematic illustration of a system 600 configured to perform the method described herein. The system 600 comprises a microscope 136 and a computer system 608. The microscope 136 is configured to take images and is connected to the computer system 608. The computer system 608 is configured to execute at least a part of a method described herein. The computer system 608 may be configured to execute a machine-learning algorithm. The computer system 608 and microscope 136 may be separate entities, but can also be integrated in one common housing. The computer system 608 may be part of a central processing system of the microscope 136 and/or the computer system 608 may be part of a subcomponent of the microscope 136, such as a sensor, an actor, a camera or an illumination unit, etc. of the microscope 136.

The computer system 608 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 608 may comprise any circuit or combination of circuits. In one embodiment, the computer system 608 may include one or more processor, which can be of any type. Herein, processor may mean any type of computational circuit, such as, but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 608 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system X20 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 608 may also include a display device, one or more speakers, and a keyboard and/or controller, which can include a mouse, trackball, touch screen, voice-recognition device, or any other device that permits a system user to input information into and receive information from the computer system 608.

Some or all of the method steps may be executed by (or using) a hardware apparatus, for example, a processor, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code maybe stored for example on a machine readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured or adapted to perform one of the methods described herein.

A further embodiment comprises a computer having the computer program installed thereon for performing one of the methods described herein.

A further embodiment according to the invention comprises an apparatus or a system configured to transfer (for example, electronically or optically) a computer program for performing one of the methods described herein to a receiver. The receiver may be a computer, a mobile device or a memory device for example. The apparatus or system may comprise a file server for transferring the computer program to the receiver for example.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine learning algorithm may comprise a feature learning component. Feature-learning algorithms, which may be called representation learning algorithms, may preserve the information in their input, but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. For example, the rules may be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as in a retina or a brain. ANNs comprise a plurality of interconnected nodes and a plurality of connections, so-called edges, between the nodes. There are usually three types of nodes, input nodes that receive input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph.

Alternatively, the machine-learning model may be based on a genetic algorithm, which is a search algorithm and heuristic technique that mimics the process of natural selection.

### REFERENCE SIGNS

101 data processing device
102 imaging apparatus
104 length threshold value
106 input image data
108 digital input image
110 shading signal
112 brightness decrease
114 edge
115 corners
116 content signal
118 image features
120 length
122 baseline image
124 estimate
126 digital output image
128 estimate
130 photon count image
132 size
134 fit
136 microscope
138 embedded processor
140 image-forming section
142 microscope camera
144 object
146 sample
148 illumination
150 optical objective
152 lens
154 image storage section
156 output image data
158 external monitor
301 multiple digital input images
302 averaged baseline image
304 multiple digital output images
306 optional step
401 scanner
402 image sensor
404 object slide
406 integrated display
501 method
502 method step (obtaining)
504 method step (accessing)
506 method step (computing)
508 method step (generating)
510 iterative minimization scheme
512 least-square minimization criterion
514 user input
516 averaged input image data
518 convergence criterion
520 optional step
600 system
601 computer program
602 computer-readable medium
604 processor
606 photon counter
608 computer
610 workstation
612 program code
614 image input section
701 tile-scan
m number of input image locations
M least-square minimization criterion
P penalty term
C cost function
r regularization parameter
λ threshold length
s peak threshold value
φ truncated quadratic term
X image location
O output image data
I input image data
c convergence threshold value
D₁ auxiliary data
G Green's function
F_{b} baseline image

1. A data processing device for an imaging apparatus, the device being configured:
to obtain a length threshold value,
to access input image data representing at least one digital input image, wherein the input image data comprise
a shading signal representing a brightness decrease towards the edges of the at least one digital input image, and
a content signal representing image features of the at least one digital input image, the image features having a length that is smaller than the length threshold value,
to compute a baseline image based on the input image data and the length threshold value, wherein the baseline image is representative of an estimate of the shading signal,
to generate at least one digital output image representative of an estimate of the content signal by at least one of
subtracting the baseline image from the input image data and
dividing the input image data by the baseline image.

2. The data processing device according to claim 1, wherein the at least one digital input image is a photon count image and the at least one digital output image is generated by dividing the input image data by the baseline image.

3. The data processing device according to claim 1, wherein the length threshold value depends on a size of the at least one digital input image.

4. The data processing device according to claim 1, wherein the device is configured to compute the baseline image using a fit to the input image data, and wherein the fit is calculated by an iterative minimization scheme.

5. The data processing device according to claim 4, wherein the iterative minimization scheme comprises a least-square minimization criterion, which is to be minimized for the fit, wherein the least-square minimization criterion comprises a penalty term and a cost function.

6. The data processing device according to claim 5, wherein the penalty term includes a derivative of the baseline image.

7. The data processing device according to claim 5, wherein the cost function represents a difference between the input image data and the baseline image.

8. The data processing device according to claim 5, wherein the iterative minimization scheme comprises a first iterative stage and a second iterative stage, wherein,
in the first iterative stage auxiliary data are updated depending on the baseline image of a previous iteration, a truncated quadratic term and the input image data and,
in the second iterative stage, the baseline image is computed using a convolution of a discrete Green's function with a sum of the input image data and the updated auxiliary data.

9. The data processing device according to claim 1, wherein the input image data represent multiple digital input images.

10. The data processing device according to claim 9, wherein the device is configured
to compute the baseline image for each of the multiple digital input images, and
to calculate an averaged baseline image based on the baseline images of the multiple digital input images.

11. The data processing device according to claim 10, wherein the device is configured to generate multiple digital output images by at least one of
subtracting the averaged baseline image from the input image data and
dividing the input image data by the averaged baseline image.

12. The data processing device according to claim 9, wherein the device is configured:
to calculate averaged input image data from the multiple digital input images,
to compute an averaged baseline image based on the averaged input image data and the length threshold value, and
to generate multiple digital output images by at least one of
subtracting the averaged baseline image from the input image data and
dividing the input image data by the averaged baseline image.

13. An imaging apparatus comprising a data processing device according to claim 1,
wherein the apparatus is configured to record the input image data representing the at least one digital input image.

14. A computer-implemented method for processing input image data of an imaging apparatus, the method comprising the steps of:
obtaining a length threshold value,
accessing input image data representing at least one digital input image, wherein the input image data comprise
a shading signal representing a brightness decrease towards the edges of the at least one digital input image, and
a content signal representing image features of the at least one digital input image, the image features having a length that is smaller than the length threshold value,
computing a baseline image based on the input image data and the length threshold value, wherein the baseline image is representative of an estimate of the shading signal,
generating at least one digital output image representative of an estimate of the content signal by at least one of
subtracting the baseline image from the input image data and
dividing the input image data by the baseline image.

15. A method for operating an imaging apparatus, the method comprising the steps of:
recording input image data representing at least one digital input image, and
carrying out the computer-implemented method according to claim 14.

16. A non-transitory, computer-readable medium comprising a program code that, when the program code is executed on a processor, a computer, or a programmable hardware component, causes the processor, computer, or programmable hardware component to perform the method of claim 14.

17. A neural network device trained by a plurality of digital input images and a plurality of digital output images, where the digital output images are computed from the digital input images with the data processing device according to claim 1.
